(19) United States
(12) Patent Application Publication
(10) Pub. No.: US 2011/0037408 A1
(43) Pub. Date: Feb. 17, 2011

(54) Method for Operating a Gas Discharge Lamp and Lighting System Comprising a Gas Discharge Lamp

(76) Inventors: Kirsten Fuchs, Kissing (DE); Achim Hilscher, Friedberg (DE); Thomas Noll, Kipfenberg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/989,194

(22) PCT Filed: Mar. 12, 2009
(86) PCT No.: PCT/EP2009/052949

§ 371 Date: Oct. 22, 2010

(30) Foreign Application Priority Data
Apr. 29, 2008 (DE) 10 2008 021 351.9

(51) Int. Cl. H05B 41/36

(52) U.S. Cl. 315/291

(57) ABSTRACT

A method for operating a discharge lamp (1), wherein, during operation of the discharge lamp (1), an electrical heating current (I_{H}) and an electrical discharge current (I_{d}) are supplied at least temporarily to an electrode (6, 7). During undimmed operation of the discharge lamp (1), the value (SoS1, SoS2) of the sum of the squares of the electrical currents (I₁, I₂) supplied via power supply lines (8, 9, 10, 11) connected to an electrode (6, 7) is set in an interval of between 1.2 times the square of a test current (I_{T}) predetermined for the discharge lamp (1) and 2 times the square of this test current (I_{T})

### TECHNICAL FIELD

The invention relates to a method for operating a discharge lamp, in which, during operation of the discharge lamp, an electrical heating current and an electrical discharge current are supplied at least temporarily to the electrodes of the discharge lamp. Furthermore, the invention relates to a lighting system with a discharge lamp and an operating device for the discharge lamp, by means of which an electrical heating current and an electrical discharge current can be supplied to the electrodes of the discharge lamp at least temporarily during operation of the discharge lamp.

### PRIOR ART

Discharge lamps with a wide variety of designs and uses are known. During operation of a discharge lamp, a large number of physical effects take place which result in the light generation of the discharge lamp. In this context, interaction between the discharge of the fill gas located in the discharge vessel and the lamp electrodes also occurs. These physical effects also have a greater or lesser influence on the life of the discharge lamp or subcomponents thereof.

### DESCRIPTION OF THE INVENTION

The object of the present invention is to provide a method for operating a discharge lamp and a lighting system with a discharge lamp, in which the life of the discharge lamp can be extended.

This object is achieved by a method having the features according to claim 1 and a lighting system having the features according to claim 9.

In a method according to the invention for operating a discharge lamp, during operation of the discharge lamp, an electrical heating current and an electrical discharge current are supplied at least temporarily to at least one electrode of this discharge lamp. An essential concept of the invention consists in that, during rated operation of the discharge lamp, the value of the sum of the squares of the electrical currents supplied via power supply lines connected to the electrode during operation of the discharge lamp is set in an interval of between 1.2 times the square of the value of a test current predetermined for the discharge lamp and two times the square of the value of this electrical test current. By virtue of this mode of operation and by virtue of specific matching of electronic operational parameters, namely the currents, it is possible in a very specific operating phase, namely during rated operation or undimmed operation (generally at rated current) of the discharge lamp, to achieve an operating mode which results in a substantial extension of the life of the discharge lamp.

Preferably, the electrical currents supplied via the power supply lines to an electrode are set in an interval of between 1.3 times the square of an electrical test current predetermined for the discharge lamp and 1.8 times the square of this test current. It has proven to be particularly preferable if the electrical currents supplied via the power supply line to the electrode are set in an interval of between 1.35 times the square of an electrical test current predetermined for the discharge lamp and 1.5 times the square of this test current. Precisely this is a particularly preferred interval of values with which, firstly, the lamp life can be substantially increased and, secondly, the system efficiency is very high since only a relatively low supplied energy requirement is necessary for the electrode heating.

The lamp life can therefore be increased by an electronic operational parameter which has been matched in a suitable manner, namely the electrical currents, in particular the heating currents and the discharge currents, with it being possible for this to be achieved during rated operation.

Preferably, a first proportion of the discharge current, which has a different value than the second proportion of the discharge current supplied via a second power supply line, is supplied to the electrode via a first power supply line. Therefore, an asymmetrical supply of the discharge current to the electrode is preferably implemented, as a result of which a considerably positive influence on the extension of the lamp life, on the one hand, and the system efficiency as regards additionally required energy supply are achieved.

In a particularly preferred manner, at least 90% of the discharge current is supplied via a power supply line to the electrode, in particular all of the discharge current is supplied via only one of the power supply lines to the electrode.

Provision can preferably be made for both the heating current and the discharge current to each be supplied completely via an identical power supply line. This is a particularly effective procedure for improving the mode of operation with a view to extending the lamp life and providing a minimal further supply of energy.

In particular, the electrical test current is predetermined in a lamp-specific manner such that it heats the electrode to a value of the warm-to-cold resistance ratio of 4.75, as prescribed by an TEC standard.

The test current is a current value which has been fixed in a lamp-specific manner, as a result of which this basic parameter can easily be used to make it possible to set the value for the sum of the squares of the electrical currents between the interval of 1.3 and 2, preferably 1.3 and 1.5, further preferably 1.35 and 1.5 of the square of the test current in a manner which is simple and involves little complexity.

The rated operation of the discharge lamp is in particular characterized by a range of the discharge current in which this discharge current is greater than or equal to 80% of the test current of the discharge lamp, as is also prescribed by an IEC standard. Precisely for this specific range of the rated operation, no provision has been made until now or it has not been known until now to perform specific setting of the heating current and the discharge current in order to be able to achieve an extension of the lamp life on the basis of the physical effects then occurring.

Preferably, the heating current is supplied continuously to the electrode during operation of the discharge lamp. By virtue of continuous electrode heating or filament heating, a particularly positive effect on the extension of the lamp life can be achieved.

Preferably, an electrical current which is supplied via a power supply line to the electrode has a heating current and/or a discharge current. Provision is particularly made for an electrode to be connected to two power supply lines, via which the energy, in particular the electrical current, is supplied to the electrode. The value of the sum of the supplied electrical currents is therefore formed from a sum which is formed firstly by the currents which are supplied to the electrode via the first power supply line and secondly by the currents which are supplied to the electrode via the second power supply line. Depending on the operation and the supply, which in particular is designed to be asymmetrical, it is possible, for example, for the electrical current supplied via the first power supply line to have a proportion of the heating current and a proportion of the discharge current. Preferably, on the basis of the asymmetrical design, provision is made for this electrical current via the first power supply line to comprise all of the heating current and all of the discharge current. With such a design, the current conducted via the second power supply line is then equal to the heating current.

However, provision can also be made for the electrical current which is supplied via the first power supply line to only supply a proportion of less than 100% of the discharge current to the electrode, in which case the electrical current which is supplied via the second power supply line to the electrode supplies the respectively remaining proportion up to 100% plus the heating current to this electrode.

The invention therefore cites a range for the preferably continuous filament heating current during electronic operation of a discharge lamp which makes it possible to significantly extend the life of the discharge lamp. In this case, the current is expressed in terms of the so-called SoS (sum of squares) value, which represents the value of the sum of the squares of the electrical currents supplied via a power supply line connected to the electrode. By virtue of the preferable standardization of this SoS value to the square of the current which heats the electrode or the lamp filament to a preferable warm-to-cold resistance ratio of R_{w}/R_{c} equal to 4.57, the SoS range for an optimized lamp life can generally be specified for each discharge lamp in which this current value is known. This current value is generally referred to as the test current I_{T} and is listed in the data sheets for many IEC 60081 and IEC 60901 discharge lamps.

By virtue of the selection according to the invention of the suitable range for the SoS value during undimmed lamp operation and therefore during rated operation of the lamp, the lamp life can be increased by up to a factor of 2 without any changes needing to be made to the lamp design. In the preferred range of this SoS value, in particular in the interval of between 1.3 times the square of the test current and 1.5 times the square of the test current, the estimated power loss of the lighting system comprising an operating device for the discharge lamp and the discharge lamp which is required for the additional heating of the electrode is less than one watt.

It has proven to be particularly preferable if the SoS value for the first filament of the discharge lamp is different than the SoS value of the second filament of the discharge lamp. This means that an electrode or a lamp filament of the discharge lamp limits the lamp life in a defined manner, as a result of which a steeper failure curve can be achieved.

Preferably, during rated operation of the discharge lamp, the value of the sum of the squares of the electrical currents supplied via power supply lines connected to a first electrode of the discharge lamp is set at least partially to be different than the value of the sum of the squares of the electrical currents supplied via power supply lines connected to a second electrode of the discharge lamp. This also makes it possible to improve the ratio between the extension of the lamp life and the system efficiency since, by virtue of this asymmetrical design of the filament heating, the gradient of the failure curve can be enlarged.

A lighting system according to the invention comprises at least one discharge lamp and at least one operating device for operating the discharge lamp, it being possible for an electrical heating current and an electrical discharge current to be supplied at least temporarily to at least one electrode by means of

the operating device during operation of this discharge lamp. An essential concept of the invention consists in it being possible, during rated operation of the discharge lamp, for the value of the sum of the squares of the electrical currents supplied via power supply lines connected to an electrode to be set in an interval of between 1.3 times the square of the value of an electrical test current predetermined for the discharge lamp and 2 times the square of the value of this test current. The lamp life can be significantly increased thereby, with it furthermore being possible in this regard for the system efficiency to nevertheless be kept high.

Advantageous configurations of the method according to the invention can be considered to be advantageous configurations of the lighting system according to the invention.

### BRIEF DESCRIPTION OF THE DRAWINGS

An exemplary embodiment of the invention will be explained in more detail below with reference to schematic drawings, in which:

FIG. 1 shows a schematic illustration of an exemplary embodiment of a lighting system according to the invention;

FIG. 2 shows a simplified graph in which the lamp life Z is shown as a function of the SoS value; and

FIG. 3 shows a simplified graph in which the SoS value is shown as a function of the rated discharge current outside of rated operation.

### PREFERRED EMBODIMENT OF THE INVENTION

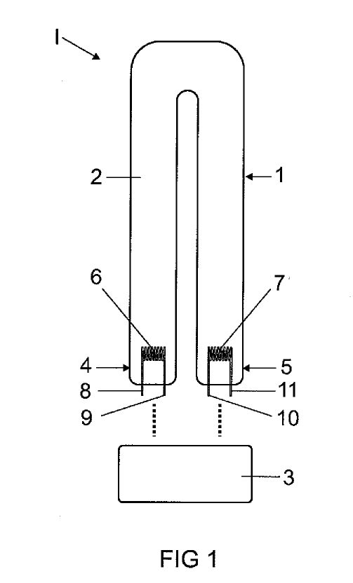

FIG. 1 shows a simplified, schematic illustration of a lighting system I, which has at least one discharge lamp 1 which is in the form of a compact fluorescent lamp in the exemplary embodiment. The discharge lamp 1 comprises a discharge vessel 2, which has curved subregions in the exemplary embodiment, which subregions are designed to be tubular. Furthermore, the lighting system I comprises an operating device 3 for operating the discharge lamp 1, it being possible for the operating device 3 to be designed to be separate from the discharge lamp 1, but it also being possible for said operating device 3 to be integrated in a housing (not illustrated) of the discharge lamp 1. In this case, the ends 4 and 5 of the discharge vessel 2 also extend into this housing.

In the exemplary embodiment, the discharge lamp 1 comprises electrodes in the form of lamp filaments 6 and 7, wherein the first electrode 6 is arranged in the region of one end 4 of the discharge vessel 2 and extends into the interior or into the discharge space of the discharge vessel 2. Correspondingly, the second lamp filament 7 is also fuse-sealed in an gas-tight manner in the region of the other end 5 of the discharge vessel 2 and extends into the discharge space of the discharge vessel 2.

The first lamp filament 6 is connected to two power supply lines 8 and 9, which are connected in turn to the operating device 3 for supplying energy to the lamp filament 6. Furthermore, the second lamp filament 7 is connected to power supply lines 10 and 11, which are also connected electrically to the operating device 3 for supplying energy to the lamp filament 7.

The lighting system I is designed in such a way that an electrical heating current I_{H} and an electrical discharge current I_{d} can be supplied at least temporarily to the electrodes 6 and 7 during operation of the discharge lamp 1.

The discharge lamp 1 is characterized in terms of its specific design also by the fact that it has a fixed or standardized test current I_{T} or is characterized by this test current I_{T}. Furthermore, the discharge lamp 1 and also the lighting system I are specified to the extent that they have an associated electrical rated current or rated discharge current, which can be used to characterize the rated operation. The electrical rated current I_{d, rated} is predetermined for the specific discharge lamp 1 and the specific lighting system I.

During rated operation of the discharge lamp 1 and therefore also the lighting system I, the value of the sum of the squares of the electrical currents supplied via power supply lines 8 and 9 connected to the first electrode 6 can be set in an interval of between 1.3 times the square of a test current value I_{T} predetermined for the discharge lamp 1 and two times the square of this test current I_{T}.

The value of the sum of the squares which is predetermined by the SoS1 value for the first electrode 6 is given by the following formula:

SoS1=−I₁₁²+I₁₂²; where
I₁₁=I_{11d}+I_{11H}
I₁₂=I_{12d}+I_{12H}

The SoS1 value therefore denotes the electrical currents supplied via the power supply lines 8 and 9 to the first electrode 6. In this context, the electrical current relates to the electrical current supplied via the power supply line 8, which current can comprise the discharge current I_{11d} supplied via this power supply line 8 and the heating current I_{11H} supplied via this power supply line 8. Correspondingly, the electrical current I₁₂ denotes the current which can be supplied via the second power supply line 9 to the first electrode 6, which current can likewise comprise the discharge current I_{12d} supplied via the power supply line 9 and the heating current I_{12H} supplied via this power supply line 9.

Provision is preferably made for there to be an asymmetrical supply of the electrical currents to the first electrode 6, which means that different proportions of the discharge current are supplied to the electrode 6 via the power supply lines 8 and 9. Provision is preferably made for all of the discharge current I_{d} to be supplied via one of the two power supply lines 8 or 9.

Correspondingly, during rated operation of the discharge lamp 1, a value SoS2 is set, which denotes the value of the sum of the squares of the electrical currents I₂₁ and I₂₂ supplied via power supply lines 10 and 11 connected to the second electrode 7, while the electrical current I₂₁ denotes the electrical current which can be supplied via the power supply line 10 and the electrical current I₂₂ denotes an electrical current which can be supplied via the power supply line 11. The SoS2 value can be represented by the following formula:

SoS2=I₂₁²+I₂₂²; where
I₂₁=I_{21d}+I_{21H}
I₂₂=I_{22d}+I_{22H}

The electrical current I₂₁ which can be supplied via the power supply line 10 in turn comprises, if appropriate, a proportion of the discharge current I_{21d} and, if appropriate, a proportion of the heating current I_{21H}. Similarly, the electrical current I₂₂ which can be supplied via the power supply line 11 comprises a proportion of the discharge current I_{22d} and, if appropriate, a proportion of the heating current I_{22H}. In this case, too, the power supply to the second electrode 7 can have an asymmetrical design, in a manner corresponding to the explanation relating to the power supply to the first electrode 6, which means that preferably all of the discharge current is supplied to the second electrode 7 via one of the two power supply lines 10 or 11.

In particular, provision can also be made for the discharge currents and heating currents supplied via at least one power supply line 8 and/or 9 to preferably be different than the discharge currents and heating currents supplied via at least one power supply line 10 and/or 11 to the second electrode 7. As a result, the gradient of the failure curve can be enlarged and therefore the lamp life can once again be extended.

The values of the sum of the squares of the electrical currents supplied via power supply lines 8, 9 and 10, 11 connected to an electrode 6 and 7, respectively, are in an interval of between 1.35 times the square of the test current I_{T} predetermined for the discharge lamp 1 and 1.5 times the square of the test current I_{T}. The following preferably applies:

1.35 I_{T}²<SoS<1.5 I_{T}²

During this rated operation, during which the discharge current is greater than or equal to 80% of the electrical test current I_{T}, continuous filament heating is also performed. By virtue of the standardization of the SoS value to the square of the current which heats the lamp filaments 6 and 7 to a warm-to-cold resistance ratio R_{w}/R_{c}=4.75, the SoS range can be specified for an optimized lamp life generally for any discharge lamp in which this current value is known.

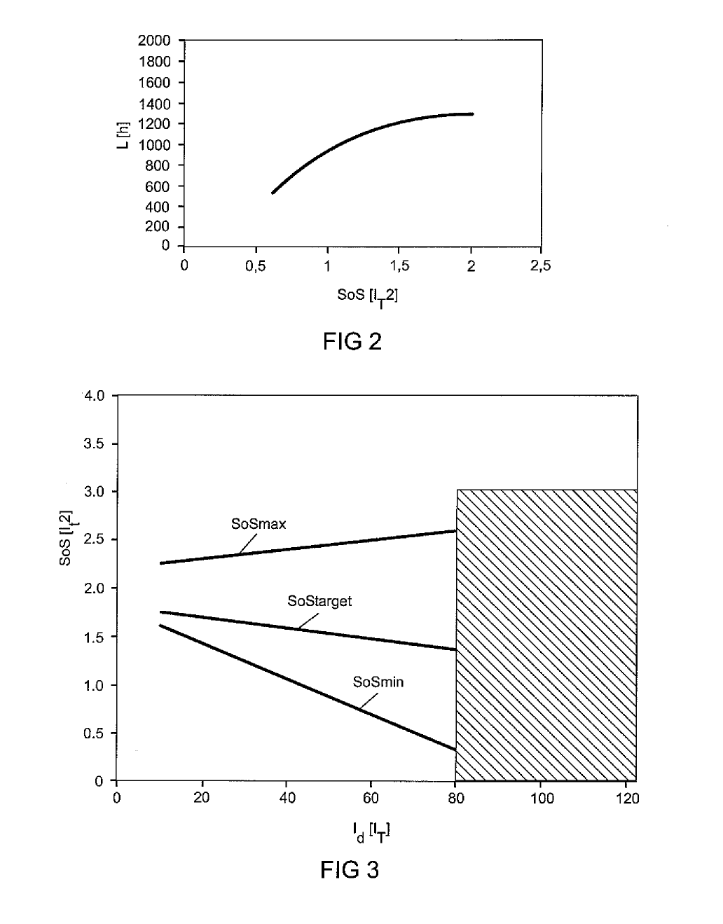

FIG. 2 shows a graph in which the lamp life is specified as a function of the standardized SoS value. It can clearly be seen that a considerable extension of the lamp life can be achieved in the specific value range of between 1.2 and 2, in particular between 1.3 and 1.8, in particular between 1.35 and 1.5.

FIG. 3 shows a graph in which the SoS value is shown as a function of the rated discharge current I_{d,rated}. For the range outside of rated operation, which is below 80% of I_{T} in the illustration, three falling and linear characteristics are plotted by way of example. In contrast, the invention relates to the range of greater than 80% of I_{T} in which the SoS value is then preferably set to between 1.35 times I_{T}² and 1.5 times I_{T}².

1. A method for operating a discharge lamp, wherein, during operation of the discharge lamp, an electrical heating current and an electrical discharge current are supplied at least temporarily to an electrode, and
wherein during undimmed operation of the discharge lamp, the value of the sum of the squares of the electrical currents supplied via power supply lines connected to an electrode is set in an interval of between 1.2 times the square of a test current predetermined for the discharge lamp and 2 times the square of this test current.

2. The method as claimed in claim 1, wherein
the electrical currents supplied via the power supply lines to an electrode are set in an interval of between 1.3 times the square of the test current predetermined for the discharge lamp and 1.8 times the square of the test current.

3. The method as claimed in claim 1, wherein
the electrical currents supplied via the power supply lines to the electrode are set in an interval of between 1.35 times the square of the test current predetermined for the discharge lamp and 1.5 times the square of the test current.

4. The method as claimed in claim 1, wherein,
a first proportion of the discharge current which has a different value than the second proportion of the discharge current which is supplied via an associated second power supply line, is supplied via an associated first power supply line.

5. The method as claimed in claim 4, wherein
at least 90% of the discharge current is supplied via a power supply line to an associated electrode, in particular all of said discharge current being supplied via only one of the power supply lines associated with the electrode.

6. The method as claimed in claim 1, wherein
during rated operation of the discharge lamp, the value of the sum of the squares of the electrical currents supplied via power supply lines connected to a first electrode of the discharge lamp is set at least temporarily to be different than the value of the sum of the squares of the electrical currents supplied via power supply lines connected to a second electrode of the discharge lamp.

7. The method as claimed in claim 1, wherein
the heating current is supplied continuously to the electrode during operation of the discharge lamp.

8. The method as claimed in claim 1, wherein
an electrical current, which is supplied via a power supply line to the electrode, has a heating current and/or a discharge current.

9. A lighting system with a discharge lamp and an operating device for the discharge lamp with which an electrical heating current and an electrical discharge current can be supplied to an electrode of the discharge lamp at least temporarily during operation, wherein
during undimmed operation of the discharge lamp, the value of the sum of the squares of the electrical currents supplied via power supply lines connected to an electrode can be set in an interval of between 1.2 times the square of a test current predetermined for the discharge lamp and 2 times the square of this test current.
